(19) United States
(12) Patent Application Publication
(10) Pub. No.: US 2010/0192987 A1
(43) Pub. Date: Aug. 5, 2010

(54) METHOD AND TECHNICAL EMBODIMENT FOR THE CLEANING OF SURFACES BY MEANS OF A HIGH-PRESSURE CLEANING DEVICE USING ELECTROLYZED WATER BY USING OXIDATIVE FREE RADICALS

(76) Inventor: Hanspeter Steffen, Rueti b. Lyssach (CH)

Correspondence Address: BIRCH STEWART KOLASCH & BIRCH, PO BOX 747, FALLS CHURCH, VA, 22040-0747, US

(21) Appl. No.: 12/679,880

(22) PCT Filed: Sep. 23, 2008
(86) PCT No.: PCT/CH08/00393

§ 371 Date: Mar. 24, 2010

(30) Foreign Application Priority Data
Sep. 25, 2007 (CH) 1483/07

(51) Int. Cl. B08B 3/00; C25B 9/00

(52) U.S. Cl. 134/34; 204/242; 204/229.4

(57) ABSTRACT

A method and technical execution, for the chemical and residue-free cleaning, hygienization, disinfection and odor neutralization of surfaces, materials, and objects by means of a high-pressure cleaning device and an electrolysis generators using electrolyzed cold or warm water, with the aid of oxidative groups, characterized in that the method, in combination with high pressure and oxidative radicals produced by electrolysis from salt ion-containing water, in total group concentrations of at least 35 ppm and higher, is able to not only clean surfaces, materials, and objects, but also to disinfect them, and is able to, by means of cold oxidation, in the form of ultrafast superoxidation, to eliminate 99.9% of microorganisms such as viruses, gram-positive and gram-negative bacteria, yeasts, fungi, algae and protozoa organisms and the like, without forming resistances in the microorganisms or pathogens.

### TECHNICAL FIELD

The invention relates to a novel chemical- and residue-free method for cleaning, sanitation, disinfection and odor neutralization of surfaces, materials and objects by means of a high-pressure cleaning device using electrolyzed cold or warm water and by using oxidative free radicals.

### PRIOR ART

To date, surfaces, materials and objects have only been hygienically cleaned by means of a high-pressure cleaning device using chemical products and disinfectants or hot water, which is very expensive and in addition is an enormous pollution of the environment by chemical-containing waste waters which are difficult to purify and pollute biological purification stages in waste water purification.

The novel invention is intended to demonstrate that using a high-pressure cleaning device and using electrolyzed water by means of oxidative free radicals, and thanks to an ultrarapid superoxidation, surfaces, materials and objects can be cleaned, sanitized and disinfected without the expensive use of environmentally polluting and toxic chemicals and energy-wasting hot water.

### DESCRIPTION OF THE INVENTION

Introduction

The object of the invention is to specify a novel, inexpensive, efficient, environmentally friendly, biological and residue-free method for hygienically cleaning and disinfecting surfaces, materials and objects by means of a high-pressure cleaning device and using electrolyzed water by means of oxidative free radicals, thanks to an ultrarapid superoxidation.

### INTRODUCTION

Electrolytically produced oxidative water (EOW)

Electrolytically oxidative water (EOW) or chemically active water destroys microorganisms such as viruses, bacteria, fungi, yeasts and single-celled organisms by means of oxidative free radicals, not chemically, but physically.

Because of its high oxidation-reduction potential (ORP), “active water” damages the cell wall membranes of pathogens.

The pathogen is compromised which leads to an osmotic or hydrogenic overload in the cell interior.

The damaged cell membranes permit an increased water transfer between the cell membranes which leads to a hydrogenic flooding of the cells and these are filled more rapidly than the cells can discharge the water.

This fact leads to bursting of the cells, or respectively to the cell death by pressure explosion in a few seconds.

Since this is a physical destruction principle, it is shown that no resistance results in pathogens.

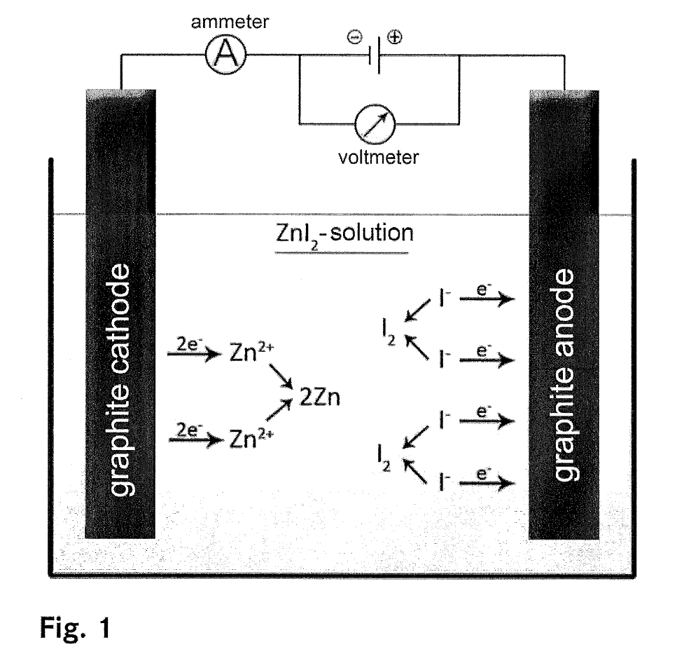

Principle of Electrolysis (cf. FIG. 1)

Example of electrolysis using a zinc iodide solution (electrode material arbitrary)

If two metal plates (electrodes) are each connected to a cable and a device which generates direct current, e.g. a battery or a rectifier, and if these plates are transferred into a glass beaker containing an aqueous solution (ions arbitrary) and a voltage is then applied, then at the two metal plates a substance forms, the ions of which are present in the solution.

The voltage source causes an electron deficit in the electrode connected to the positive terminal (anode) and an electrode excess in the other electrode connected to the negative terminal (cathode). The aqueous solution between the cathode and anode contains electrolytes, which are positively or negatively charged ions. The positively charged cations in an electrolysis cell migrate owing to the application of a voltage towards the negatively charged cathode (attraction of opposite charges). At the cathode they take up one or more electrons and are reduced thereby.

At the anode the opposite process proceeds. There the negatively charged anions release electrons, that is to say they are oxidized. The number of electrons consumed by the reduction at the cathode corresponds to the electrons taken up by the anode. During the electrolysis of aqueous sodium chloride solution, the same volume of hydrogen gas as chlorine gas is formed. In the electrolysis of water, twice as much hydrogen gas as oxygen gas is formed, since the two positively charged protons of a water molecule migrate to the cathode and there each must take up one electron to form hydrogen, whereas the doubly negatively charged oxygen anion must at the same time release two electrons at the anode in order to join to form the oxygen molecule.

The minimum voltage which must be applied for the electrolysis is called the deposition potential; in the electrolysis of water or in aqueous salt solutions, the term decomposition potential is also used. This potential (or a higher potential) must be applied in order that the electrolysis proceed at all. For any substance, for any conversion of ions to molecules containing two or more atoms, the decomposition potential, the deposition potential, can be determined on the basis of the redox potential. From the redox potential much other important information is obtained for the electrolysis, for example for the electrolytic decomposition of metal electrodes in acid or for reducing decomposition potential by modifying pHs.

For example, it is possible to calculate from the redox potential that the formation of oxygen at the anode during the electrolysis of water in basic solution (decomposition potential: 0.401 V) proceeds at a lower potential than in acidic solution (decomposition potential: 1.23 V) or neutral solution (decomposition potential: 0.815 V), and at the cathode, in contrast, hydrogen forms more readily under acidic conditions than under neutral or basic conditions.

If a plurality of reducible cations are present in an electrolyte solution, then in accordance with the redox potential series, the cations which are reduced first at the cathode are those which have in the redox potential series (electrochemical series) a more positive (less negative) potential, which therefore come closest to the zero potential of the proton-hydrogen electrode potential. During the electrolysis of an aqueous sodium chloride solution, usually hydrogen forms at the cathode and not sodium. Also in the case of the presence of a plurality of anion types which can be oxidized, those which come first are those which in the redox potential series are as close as possible to the potential null point, that is to say have a less positive redox potential. Usually, during the electrolysis of aqueous NaCl, therefore oxygen and not chlorine is formed at the anode. After exceeding the decomposition potential, with an increase in potential, the current strength also increases proportionally. According to Faraday, the weight of an electrolytically formed substance is proportional to the amount of current flowing (current strength multiplied by time). For the formation of 1 g of hydrogen (approximately 11.2 liters, in the formation of one hydrogen molecule two electrons are required) from aqueous solution, an amount of current of 96485 C (As)=1 Faraday is required. At a current strength of 1 A between the electrodes, the formation of 11.2 liters of hydrogen therefore takes 26 hours and 48 minutes.

In addition to the redox potential, the overpotential is also of importance. Owing to kinetic inhibitions at electrodes, frequently a significantly higher potential is required than is calculated from the redox potentials. The overpotential effects can change according to the material property of the electrodes, also the redox potential series, and so other ions are oxidized or reduced than would be expected from the redox potential. Shortly after switching off an electrolysis, a current shift into the other direction can be determined using an ammeter. In this short phase, the reverse process of electrolysis starts, the formation of a galvanic cell. In this case current is not consumed for the reaction, but current is briefly generated; this principle is used in fuel cells.

When by means of electrolysis separation of individual molecules or bonds is forced, a galvanic element acts at the same time, the potential of which counteracts the electrolysis. This potential is also termed the polarization potential.

Electrodes

There are very few anode electrodes which remain inert during the electrolysis—that is do not go into solution at all. Platinum, carbon or diamond are materials which do not dissolve at all during an electrolysis. There are also metals which, despite a strongly negative redox potential, do not dissolve. This is termed “passivity”. An iron anode which has been treated with concentrated nitric acid does not dissolve and no iron (II) or (III) cations pass into solution; it has “passivity”.

Inhibition phenomena at the anode which lead during oxygen formation to an overpotential are observed in the case of diamond and platinum anodes (overpotential: 0.44 V). With these, during the electrolysis of aqueous sodium chloride solution, chlorine instead of oxygen is formed. At zinc, lead (overpotential: 0.78 V) and particularly mercury cathodes (0.80 V), hydrogen protons exhibit a considerable overpotential and the formation of hydrogen only proceeds at a much higher potential. The considerable overpotential of hydrogen at the mercury cathode, in which sodium is bound as amalgam and therefore is removed from the equilibrium, is utilized for the industrial production of sodium hydroxide solution. As a result of the considerable overpotential at this electrode during the hydrogen formation, the redox potential series changes and instead of hydrogen protons, sodium cations then migrate to the mercury cathode.

Electrolysis of Water

The electrolysis of water consists of two partial reactions which proceed at the two electrodes. The electrodes are immersed in water which is made more conductive by adding some sodium chloride, wherein then instead of oxygen, chlorine is produced.

Positively charged hydronium ions (H₃O⁺) migrate in the electric field to the negatively charged electrode (cathode) where they each take up one electron. In this process hydrogen atoms are formed which combine with a further H atom resulting from reduction to give a hydrogen molecule. Water molecules remain over.

2H₃O⁺+2 e⁻→H₂+2 H₂O

The gaseous product separated off ascends at the cathode.

The negatively charged hydroxide ions migrate to the positively charged electrode (anode).

Each hydroxide ion gives off one electron to the positive terminal, and so oxygen atoms are formed which combine to form oxygen molecules or, in the case of NaCl addition, to form chlorine molecules.

The H⁺ ions remaining are immediately neutralized by hydroxide ions to form water molecules.

4OH⁻→O₂+2H₂O+4 e⁻

Here also the oxygen which is separated off ascends as a colorless gas at the anode. The overall reaction equation of the electrolysis of water is as follows:

4H₃O⁺+4OH⁻→2H₂+O₂+6H₂O

The hydronium and hydroxide ions which are on the left-hand side originate from the autoprotolysis of water:

8H₂O→4H₃O⁺+4OH⁻

The electrolysis equation can therefore also be written as follows:

8H₂O→2H₂+O₂+6 H₂O

or shortened in terms of the water:

2H₂O→2H₂+O₂

Hydroxide ion

The hydroxide ion is a negatively charged ion which is formed when bases react with water. Its chemical formula is OH⁻.

A general base B reacts with water in the following way:

B+H₂O=HB⁺+OH⁻

The pH of the resultant solution can be determined on the basis of the concentration of the hydroxide ions. For this purpose what is termed the pOH is calculated first.

pOH=−log c(OH⁻)

And therefrom the pH:

pH=k−pOH

For each temperature there is in each case one k.

Under standard conditions k=−14.

Hydroxide ions are also present in pure water at 20° C. at a concentration of 10⁻⁷ mol·l⁻¹. This is associated with the autoprotolysis of water according to the following reaction equation:

H₂O+H₂O=H₃O⁺+OH⁻

Approval

The innovative use of diamond electrode technology in electrolysis has recently received great attention by numerous university research teams for use in surface disinfection.

Our own early experiments and experimental results led to the submission of approval requests in the FDA (USA Food and Drug Administration) which in December 2002 granted approval for the novel technology and the status generally recognized as safe (“GRAS”).

Electrolyzed oxidative water received FDA (USA Food and Drug Administration), USDA (US Department of Agriculture) and EPA (USA Environmental Protection Agency) approval for general applications in the food sector, for food surface disinfection, and for milk, meat and restaurant technical applications.

The corresponding pages of the approval numbers of the FDA and USDA are 21 CFR 173, 178, 182, 184 & 198.

The EPA approval and publication page is 40 CFR 180.940 and that of the National Organic Program is 21 CFR 178.1010.

Description of the Method Components

The method contains the following technical auxiliaries and process steps:

Technical Auxiliaries

1. Commercially available high-pressure cleaning device with or without hot water preparation preferably having 0-20 bar or more pressure generation pump; all parts non-corroding, with electrical or other motorized drive, spray lance having various valves and nozzles.
2. Electrolysis generator having one or more electrolysis cells, single-chamber or double-chamber with diaphragm, pump preferably made of non-corroding steel or plastic, filters, flowmeters, pressure control preferably with two taps and two manometers, electrical water-flow sensor, electronic control unit having time-controlled automatic electrode polarity reversal, redox meter, water storage tank with inlet and outlet taps, water lines, nonreturn valve. Electronically programmable control unit having switch, electronic water level control with electronic feed valve, on and off switch lever. Time-measurement and timer switch, water inlet and outlet lines to high-pressure cleaner.

Production of the Biocidal Oxidative Free Radicals in Aqueous Salt-Containing Solution by Means of Electrolysis

The biocidal oxidative free radicals can be produced in aqueous salt-containing solution by two different electrolysis methods.

The first method is implemented using diamond electrolysis by means of diamond-coated electrodes. This process forms a cocktail of oxidative free radicals close to the “neutral range” with a pH of 6.4 to 6.8. At the anode, in addition to OH— hydroxyl groups and O₃, primarily free chlorine (Cl—) is formed which all, together with the hydroxyl groups, lead to the formation of hypochloride HOCL and hypochloride acid H₂OCL which are broken down very rapidly organically. In order to be able to carry out the electrolysis of water more favorably and better with respect to current consumption, NaCl salt is added to the water because of the improved electrical conductivity.

During the electrolysis of these salt compounds, in addition oxidizing molecules are formed such as reducing peroxodisulfate, peroxodisphosphate and percarbonate.

The NaCl salt concentration is, per liter of water:

Preferably 0.5-8 gram of NaCl (sodium chloride) or more.

The second method is implemented using cylinder electrolysis with diaphragm, where the electrolysis cells are separated from one another, consisting of an anode chamber and a cathode chamber. At the positive anode made of platinum, acid-forming negatively charged anions form in an acidic range of approximately 2.4 pH with negative charge, and at the negative cathode base-forming positive cations form in an alkaline range of approximately 11 pH with a positive charge.

These two acidic and alkaline aqueous electrolysis solutions can now be mixed as desired and, according to the application, be used in the acidic or basic range.

During the electrolysis of pure water without salt, the following oxidative free radicals are formed:

### Electrolytic Process of Water

The various oxidative free radicals are formed when water (H₂O) is electrolyzed, for example: (E0 is the standard redox potential)*:

O2+H+e−HO2 E0=−0.13 V [1]

2H++2e−H2 E0=0.00 V [2]

HO2+H++e−H2O2 E0=+1.50 V [3]

O3+2H++2e−O2+H2O E0=+2.07 V [4]

OH−+H++e−H2O E0=+2.85 V [5]

H2O+e−H+OH−E0=−2.93 V [6]

OH+e−OH−E0=+2.02 V [7]

Electrolytic Process of Water with salt NaCl

At the cathode side

Na++e−Na

2Na+2H2O 2Na++2OH−+H2

At the anode side

2Cl−−2e−Cl2

It must be mentioned here that Cl2 (chlorine gas) and OH— react as follows:

Cl2+2OH−Cl O−+Cl−+H2O

Or

Cl2+OH−HClO+Cl−

### Solution of the Problem

The solution of the problem is defined by the features of the independent patent claims.

According to the invention the method for the chemical- and residue-free cleaning, sanitation, disinfection and odor neutralization of surfaces, materials and objects by means of a high-pressure cleaning device using electrolyzed cold or warm water and by using oxidative free radicals displays the type of biocides, in particular the specific properties of the electrolyzed oxidative water, the production thereof, the salt concentration and salt composition thereof, the redox potential thereof, and the concentration thereof in free oxidative free radicals and total concentration of the oxidative free radicals, and pH thereof and amount to be used for an efficient spraying operation by means of the high-pressure cleaning device.

According to the invention the method additionally displays the technical embodiment and use, with respect to the combination of high-pressure cleaner and electrolysis generator, for producing the oxidative free radicals and a water storage tank for deep cleaning and elimination of germs.

The invention forms an integrated system in which the technical components of the oxidative free radical production by means of the electrolytic production of oxidative free radicals in water and temporary storage in the storage tank are integrated with the corresponding application techniques in combination with a high-pressure cleaning device for deep cleaning and disinfection of surfaces, materials and objects. The center of interest of the innovation is not only the technical combination of a high-pressure cleaner with an electrolysis unit for producing oxidative free radicals, but also the novel method and application technique of the combined use of high pressure with an aqueous solution of oxidative free radicals which, thanks to ultrarapid superoxidation, can not only clean but also disinfect and are even able to dissolve biofilms.

In experiments over many years, the optimum concentrations of oxidative free radicals in water and the specific high-pressure and pressure requirements and treatment times have been investigated in order to achieve perfect cleaning and disinfection of all types of surfaces, materials and surfaces.

The inventor has tested and perfected the novel method in research and development work over many years in the laboratory and in practical use and has achieved an efficiency of close to 100%.

According to the state of knowledge of the inventor, to date no scientific work is known in the field of disinfection and cleaning of surfaces, materials and objects by means of the combination of oxidative free radicals electrolytically generated from water as biocides against germs, fungi, viruses and bacteria etc., and by means of high-pressure application as a cleaning and disinfection technique acting in depth, nor is an equivalent technology used anywhere now for the same purpose.

### Embodiment of the Invention

The invention will be described by an example of a mobile disinfection unit preferably comprising an electrolysis generator, an intermediate tank and a high-pressure cleaning device including high-pressure spray lance with a controllable nozzle, mounted on a mobile trolley chassis fitted with rubber wheels.

A mobile high-pressure disinfection and cleaning system using oxidative free radicals produced electrolytically from water for cleaning and sanitation of surfaces, materials and objects is composed of the following individual technical parts:

1. Commercially available high-pressure cleaning device (Karcher) without hot water preparation having 10 bar pressure generation pump and output of 5 liters per minute; all parts non-corroding, with electrical drive 220 V/50/60 Hertz, pistol spray lance having high-pressure spray nozzle. Compare ANNEX 1 A

2. Electrolysis generator having two single-chamber electrolysis cells connected in parallel, with boron-doped diamond electrodes, pump made of non-corroding steel having a pumping rate of 600 liters per hour and 4 bar pressure, filter of 50 mesh, flowmeter up to 900 liters per hour, pressure control preferably with two taps and two manometers, electrical water-flow sensor, electronic control unit having time-controlled automatic electrode polarity reversal, redox meter, water storage tank with inlet and outlet taps, water lines, nonreturn valve. Electronically programmable control unit having switch, electronic water level control with electronic feed valve, on and off switch button. Time-measurement and timer switch, water inlet and outlet lines to high-pressure cleaner. Compare ANNEX 1 B

3. Intermediate tank of 50 liters capacity for water with lid, emptying valve and inlet and outlet lines with taps and connection hose to high-pressure cleaner. Compare ANNEX 1 C

4. Rubber-tired mobile trolley pushcart designed as mounting-assembly chassis. Compare ANNEX 1 D

As a first working step, the device is connected to the 220 V power grid.

The electrolysis device is then switched on.

The intermediate tank of 50 liters capacity is filled with standard low-hardness water and according to requirements admixed with 0.5 to 8 grams of sodium chloride per liter, i.e. with up to 400 grams of sodium chloride (NaCl).

The preprogrammed electrolysis unit is now switched on. The corrosion-resistant pump (600 liters per hour) then pumps the water at 10 liters per minute through the electrolysis cells. There the water is electrolyzed via the diamond electrodes (anode/cathode) and oxidative free radicals are formed which cause ultrarapid superoxidation on surfaces which leads to complete disinfection and killing of microorganisms.

The water is electrolyzed until the desired concentration is produced. The programmed REDOX monitor unit automatically turns on and off or a timer switch controls the electrolysis device.

When the desired concentration of oxidative free radicals is reached, determined by the desired ORP value (oxidation-reduction potential), the high-pressure cleaning device can be switched on.

By means of a pressure on the pistol grip on the lance, the high-pressure spraying operation can then be started and the surfaces to be cleaned treated with the high-pressure water jet.

The reducing water acts like a soap product and removes not only dirt and bacterial dirt-biofilms, but likewise disinfects by killing 99.9% of all microorganisms such as viruses, Gram-positive and Gram-negative bacteria, yeasts, protozoa etc. in seconds. The oxidative water has a prolonged time of action which favors the disinfection intensity. The cleaning is perfect and no toxic residues are formed. The method can thus also be used with CIP (Cleaning In Place) applications.

The cleaning method with high pressure and oxidative free radicals is cheaper than any other cleaning method using chemicals. The energy consumption is only 600 W/h for producing 600 liters of disinfection solution.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals, wherein the technical embodiment preferably, but not exclusively or obligatorily, comprises the following components:

a) Commercially available high-pressure cleaning device with or without hot water preparation preferably having 5-20 bar or more pressure generation pump; all parts non-corroding, with electrical or other motorized drive, spray lance having various valves and nozzles.

b) Electrolysis generator having one or more electrolysis cells, single-chamber or double-chamber with diaphragm, pump preferably made of non-corroding steel or plastic or other suitable materials, filters, flowmeters, pressure control preferably with two taps and two manometers, electrical water-flow sensor, electronic control unit having time-controlled automatic electrode polarity reversal, redox meter, water storage tank with inlet and outlet taps, water lines, nonreturn valve. Electronically programmable control unit having switch, electronic water level control with electronic feed valve, on and off switch lever. Time-measurement and timer switch, water inlet and outlet lines to high-pressure cleaner, grounding cable and power lines with plug, operating time meter, emergency switch and fuse box.

c) Mounting chassis, preferably mobile.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals, wherein the high-pressure cleaner can generate a pressure of 1-20 bar or more, consists of non-corroding parts, and comprises a spray lance having an adjustable high-pressure nozzle.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals, wherein, in the method for producing oxidative free radicals in water, not only diamond electrode types but also other electrode types made of platinum or alloys and of other suitable materials can be used. In that in addition the electrolysis generator can be designed having one or more electrolysis cells, as a single chamber or, as a cylinder cell, as a double chamber with diaphragm.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals, wherein the entire application system consisting of high-pressure cleaner, intermediate tank for water and electrolysis generator forms a unit which is connected together by lines and is mounted on a platform or a mobile chassis or as a wall model.

A method and technical embodiment is disclosed for the chemical- and residue-free cleaning, sanitation, disinfection and odor neutralization of surfaces, materials and objects by means of a high-pressure cleaning device and an electrolysis generator using electrolyzed cold or warm water by using oxidative free radicals, wherein the method in combination with high pressure and oxidative free radicals electrolytically generated from salt-ion-containing water such as, for example, hypochloride, hydrogen superoxide, ozone, hydroxyl groups, peroxodisulfate, peroxodisphosphate and percarbonate, etc., in a total free radical concentration of a minimum of 35 ppm and above, is able not only to clean surfaces, materials and objects, but also to disinfect them and is able, by means of cold oxidation in the form of an ultrarapid superoxidation, to eliminate microorganisms such as viruses, Gram-positive and Gram-negative bacteria, yeasts, fungi, algae and single-celled organisms, etc. up to 99.9%, without resistances forming in the microorganisms or pathogen

1. A device for the chemical- and residue-free cleaning, sanitation, disinfection and odor neutralization of surfaces, materials and objects, which device comprises:
a) an electrolysis generator having an electrical control unit and electrodes for generating electrolyzed water, characterized in that
b) the electrodes of the electrolysis generator comprise at least one diamond electrode, and
c) in that a high-pressure cleaning appliance is arranged to which the electrolyzed water can be fed.

2. The device as claimed in claim 1, characterized in that a diamond-coated electrode is present for generating oxidative free radicals having a pH of 6.4-6.8, in particular for the formation at the anode of, in addition to OH— hydroxyl groups and O₃, of especially free chlorine, which together with the hydroxyl groups lead to the formation of hypochloride and hypochloride acid which are organically broken down very rapidly, wherein, NaCl is added to the water for favorable influence of the current consumption and, in the electrolysis of these salt compounds, in addition oxidizing molecules such as reducing peroxodisulphate, peroxodiphosphate and percarbonate are formed.

3. The device as claimed in claim 1, characterized in that the diamond electrode is a boron-doped diamond electrode.

4. The device as claimed in claim 1, characterized in that the high-pressure cleaning appliance comprises a pressure-generation pump for a pressure of 5-20 bar and more.

5. The device as claimed in claim 1, characterized in that the electrolysis generator is constructed as a single chamber type.

6. The device as claimed in claim 1, characterized in that the electric control unit of the electrolysis generator has a time-controlled automatic electrode polarity reversal.

7. A method for the chemical- and residue-free cleaning, sanitation, disinfection and odor neutralization of surfaces, materials and objects by means of a device as claimed in claim 1, which method comprises:
a) generating electrolyzed water by means of an electrolysis generator, characterized in that
b) the electrolyzed water is fed to a high-pressure cleaning appliance.

8. The device as claimed in claim 2, characterized in that the diamond electrode is a boron-doped diamond electrode.

9. The device as claimed in claim 2, characterized in that the high-pressure cleaning appliance comprises a pressure-generation pump for a pressure of 5-20 bar and more.

10. The device as claimed in claim 3, characterized in that the high-pressure cleaning appliance comprises a pressure-generation pump for a pressure of 5-20 bar and more.

11. The device as claimed in claim 2, characterized in that the electrolysis generator is constructed as a single chamber type.

12. The device as claimed in claim 3, characterized in that the electrolysis generator is constructed as a single chamber type.

13. The device as claimed in claim 4, characterized in that the electrolysis generator is constructed as a single chamber type.

14. The device as claimed in claim 2, characterized in that the electric control unit of the electrolysis generator has a time-controlled automatic electrode polarity reversal.

15. The device as claimed in claim 3, characterized in that the electric control unit of the electrolysis generator has a time-controlled automatic electrode polarity reversal.

16. The device as claimed in claim 4, characterized in that the electric control unit of the electrolysis generator has a time-controlled automatic electrode polarity reversal.

17. The device as claimed in claim 5, characterized in that the electric control unit of the electrolysis generator has a time-controlled automatic electrode polarity reversal.

18. A method for the chemical- and residue-free cleaning, sanitation, disinfection and odor neutralization of surfaces, materials and objects by means of a device as claimed in claim 2, which method comprises:
a) generating electrolyzed water by means of an electrolysis generator, characterized in that
c) the electrolyzed water is fed to a high-pressure cleaning appliance.

19. A method for the chemical- and residue-free cleaning, sanitation, disinfection and odor neutralization of surfaces, materials and objects by means of a device as claimed in claim 3, which method comprises:
a) generating electrolyzed water by means of an electrolysis generator, characterized in that
d) the electrolyzed water is fed to a high-pressure cleaning appliance.

20. A method for the chemical- and residue-free cleaning, sanitation, disinfection and odor neutralization of surfaces, materials and objects by means of a device as claimed in claim 4, which method comprises:
a) generating electrolyzed water by means of an electrolysis generator, characterized in that
e) the electrolyzed water is fed to a high-pressure cleaning appliance.
